(19) United States
(12) Patent Application Publication
(10) Pub. No.: US 2004/0011553 A1
(43) Pub. Date: Jan. 22, 2004

(54) Extruded flat cable

(75) Inventors: David Cianciolo, Methuen, MA (US); Darryl J. McKenney, Londonderry, NH (US); Arthur DeMaso, Nashua, NH (US); Laurea J. Doiron JR., Pelham, NH (US); Steven J. Bibeau, Sandown, NH (US)

Correspondence Address: WEINGARTEN, SCHURGIN, GAGNEBIN & LEBOVICI LLP, TEN POST OFFICE SQUARE, BOSTON, MA, 02109, US

(73) Assignee: Parlex Corporation

(21) Appl. No.: 10/197,779

(22) Filed: Jul. 18, 2002

(51) Int. Cl. H02G 3/00

(52) U.S. Cl. 174/117 FF

(57) ABSTRACT

A flat multi-conductor cable and a method for manufacturing such a cable to maintain consistent spacing between adjacent conductors. A dielectric film is laminated to both sides of a plurality of conductors, such as flat copper conductors. The film is heated to cause the film to flow around and adhere to the conductors. A jacket is extruded around the dielectric film to form a jacketed multi-conductor cable. A conductive shield may be applied over the dielectric film prior to the extrusion of the cable jacket. The conductive shield may be conductively coupled to one or more of the conductors by dimpling the shield over the respective conductors or by a laser ablation technique.

### CROSS REFERENCE TO RELATED APPLICATIONS

N/A

### STATEMENT REGARDING FEDERALLY SPONSORED RESEARCH OR DEVELOPMENT

N/A

### BACKGROUND OF THE INVENTION

The present invention pertains to ribbon cables and apparatus and methods employed in the manufacture of such cables.

Known flat cables typically include a plurality of flat or round wires that are retained within an extruded insulating material. During the manufacture of such cables problems can arise when employing conventional manufacturing processes. For example variations in the distance or pitch between adjacent conductors known as “swim” often arise due to the movement of the wires in the extrusion die that result from high pressure extrusion forces. The variations in the distances between the adjacent wires result along the length of the cable produces local impedance variations that can effect the performance of an electrical circuit in which the cable is used.

The variations in spacing of the conductors within a flat cable also cause problems in making connections with the cable. For example, when using an insulation displacement connector, if the conductors do not maintain the proper spacing and position within the cable, misalignment with the IDC contacts can occur. Such misalignment can result in a faulty connection between the IDC contact and the connector contact, or a short between adjacent conductors.

Flat cables are also used in conjunction with zero insertion force (ZIF) connectors. More specifically, a ZIF connector has a first mechanical configuration that allows the flat cable to be freely inserted into and aligned within the ZIF connector with minimal insertion forces. An actuator is then employed to modify the connector to assume a second mechanical configuration in which ZIF connector electrical contacts make electrical contact with respective conductors of the flat cable. Misalignment of the conductors within the flat cable due to “swimming” in the manufacturing process can also result in faulty connections or short circuits between conductors when coupling to such cables via ZIF connectors.

Another problem with conventional flat cables is that the insulation does not adhere to the wires encapsulated therein. The wires can be pulled out the cable or can creep within the insulation and loosen within a connector such as a ZIF type connector.

It would therefore be desirable to be able to produce a flat cable that maintained accurate and uniform spacing between adjacent conductors and proper spatial registration of the conductors within the encapsulating insulation. It would further be desirable for the insulation surrounding the respective conductors to adhere to the conductors to avoid longitudinal movement of the conductors within the surrounding insulation.

### BRIEF SUMMARY OF THE INVENTION

In accordance with the present invention an improved flat cable and a method for making a flat cable having multiple conductors is disclosed. In a first embodiment of the invention, a plurality of conductors are spaced apart by a predetermined distance. An insulating film having predetermined dielectric characteristics is laminated to both sides of the plurality of conductors to maintain the spacing between the plurality of respective conductors to form a laminated multi-conductor cable. The insulating film is heated following the lamination step to cause softening of the film and flow of the insulating film around the wires. An outer layer is extruded around the laminated multi-conductor cable to provide a cable jacket that has desired mechanical and/or other jacket properties. By controlling the spacing of the conductors during the laminating process, “swim” is eliminated. The material employed for the insulating film need not be the same material employed for the extruded jacket.

In another embodiment, an electrical shield provided around the laminated multi-conductor cable and the outer jacket is extruded over the electrical shield. The shield may be a foil, screen or mesh of copper, silver or aluminum, a conductive epoxy or a conductive braid. The shield material may be provided with an anisotropic adhesive coating with z-axis conductivity on the inside surface of the shield material. After the shield layer is applied over the insulating film, the shield layer and the adhesive coating may be pressed inward to cause a dimple at one or more of the conductors. A conductive path is thereby formed between the shield and the respective conductors. Laser ablation may also be used to form the conductive connection between one or more cable conductors and the shield.

Other features, aspects and advantages of the presently disclosed flat cables and methods for manufacturing such cables will be apparent from the detailed description and drawing that follows.

### BRIEF DESCRIPTION OF THE SEVERAL VIEWS OF THE DRAWING

The invention will be more fully understood by reference to the following Detailed Description of the invention in conjunction with the Drawing of which:

FIG. 1 is a diagrammatic side plan view of apparatus for making a flat cable in a manner consistent with the present invention;

FIG. 2 is a diagrammatic top plan view of the apparatus of FIG. 1;

FIG. 3 is a diagrammatic representation of a cross-section of a cable fabricated using the apparatus depicted in FIGS. 1 and 2;

FIG. 4 is a diagrammatic side plan view of a portion of the apparatus of FIG. 1 that further includes wrapping apparatus for applying a shield following the lamination of the dielectric films to the flat conductors; and

FIG. 5 is a partial cross-sectional view of flat cable in accordance with the present invention that further includes a dimple for conductively coupling the shield to a flat conductor via an anisotropic dielectric layer.

### DETAILED DESCRIPTION OF THE INVENTION

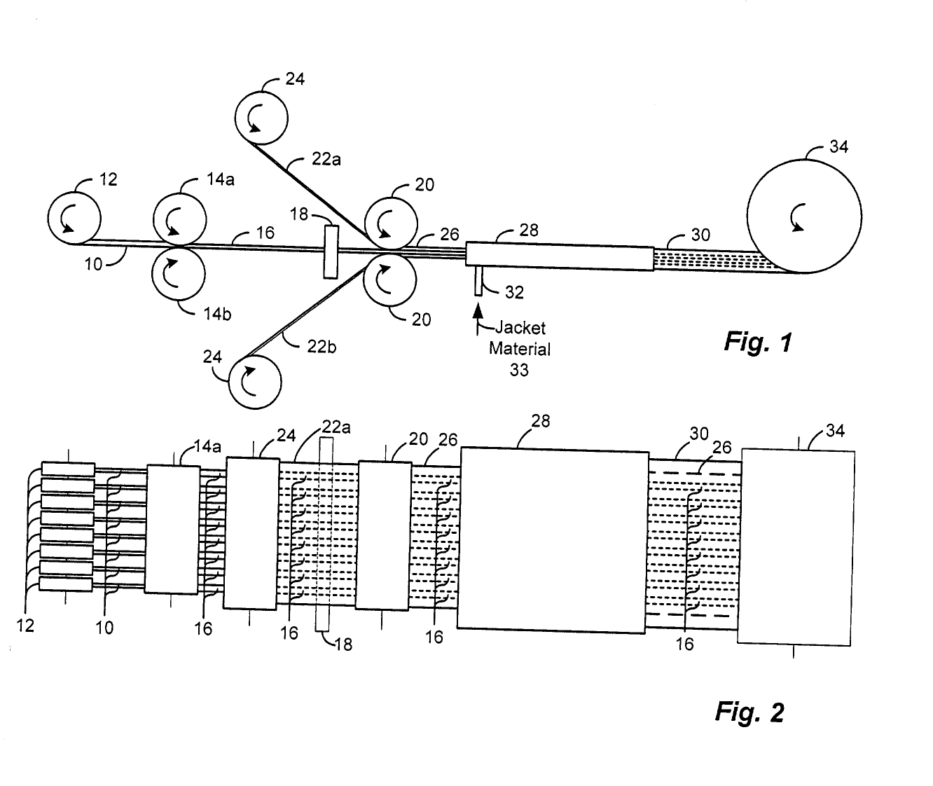

A process and apparatus for producing a flat cable in which the spacing between adjacent conductors is accurately maintained are depicted in FIGS. 1 and 2. A plurality of conductors 10 having a circular cross-section are drawn off spools 12. The round conductors 12 are passed between opposing counter-rotating swage rollers 14 that flatten the round conductors 12 to produce flat conductors 16 having a generally rectangular cross-section. The spacing between the opposing swage rollers 14 is specified to produce a flat conductor having the desired thickness. The spacing between the flat conductors 16 is accurately maintained by a spacing mechanism 18 such at a comb or a grooved roller (not shown). The flat conductors 16 pass through the comb or engage the grooved roller, as applicable, and pass between heated counter-rotating nip rollers 20.

First and second dielectric films 22a and 22b are spooled off film supply rolls 24. The dielectric films may be produced using a bag-die technique to provide a thin insulating material typically 1 - 3 mils thick. The dielectric films may comprise polyethylene, polypropylene, polyethylene terephthalate (PET), polyethylene napalate (PEN) or any other suitable dielectric films known in the art. The dielectric films 22a and 22b are laminated to the upper and lower sides respectively of the flat conductors 16 by the heated nip rollers 20. The heated nip rollers 20 cause the dielectric films 22a and 22b to soften and flow around the flat conductors 16 to form a unitary film 20 that adheres to and encapsulate the flat conductors 16. In the foregoing manner an insulated flat cable 26 is formed exiting the nip rollers 20. Due to the registration of the flat conductors 16 by the spacing mechanism 18 positioned at the entrance to the nip rollers 20 the encapsulated cable 26 exiting the nip rollers 20 has flat conductors 16 that are consistently and accurately spaced with respect to adjacent conductors and substantially devoid of “swim”.

The dielectric films 22a and 22b may be selected to provide any suitable dielectric characteristics. Moreover, the dielectric characteristics may also be tailored by adjusting the spacing between the nip rollers to control the thickness of the dielectric. Controlling the thickness of the dielectric in this manner is preferable to the use of an extrusion process since a change in the extrusion die usually requires a change to the die itself or the use of complicated adjustable dies, both of which represent expensive alternatives.

A jacket material 33 is extruded over the encapsulated cable 26 in a die 28 to form a jacket or cover 30. Since the dielectric film 22 is applied via a lamination process and the cable jacket 30 is applied via a secondary extrusion process, the jacket material 33 need not be the same as the dielectric material. Accordingly, the jacket material 33 may be specified to provide mechanical, color or any other desired characteristics for the cable jacket 30. By way of example, the jacket material may comprise a polypropylene, polyester, vinyl or rubber jacket or any other suitable jacket material known in the art.

The jacket material 33 is pumped into the die 28 through one or more ports 32 and surrounds the encapsulated cable 26. Cooling of the jacket material 33 at the exit of the die 28 or any other suitable jacket material 33 curing technique may be employed to facilitate more rapid curing of the jacket material 33 as is known in the art. The jacketed cable exits the die 28 and is stored on a take-up roll 34.

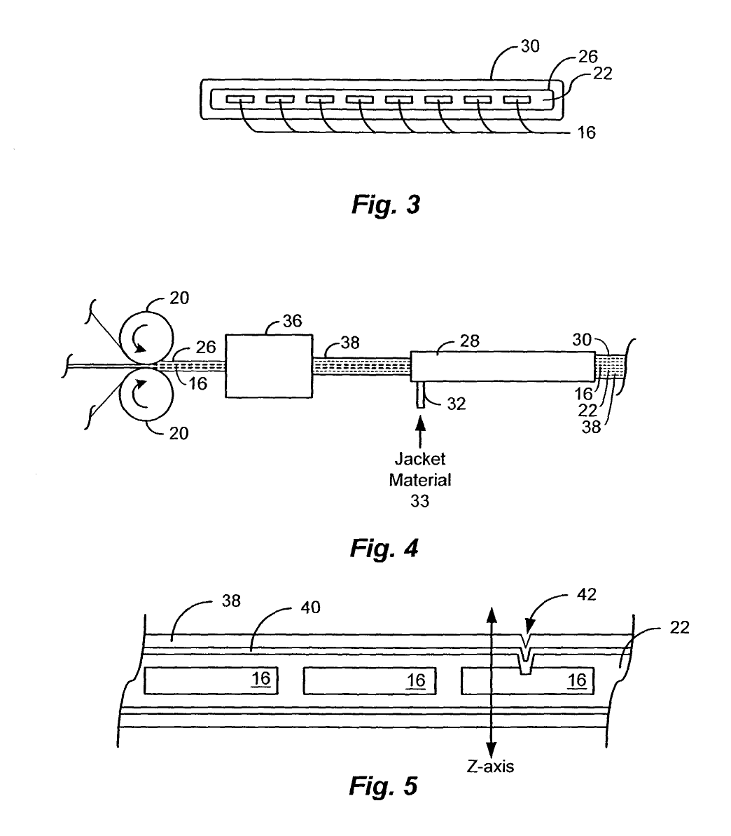

The cross section of a cable produced in accordance with the above-described process is depicted in FIG. 3. As illustrated in FIG. 3, the flat conductors 16 are encapsulated by the dielectric film 22 following the lamination of the upper and lower dielectric films 22a and 22b to the flat conductors 16 as discussed above. The jacket 30 is extruded over the encapsulated flat cable 26.

In another embodiment, electrical shielding 38 is applied over the encapsulated cable 26 prior to the extrusion of the jacket 30. More specifically, as depicted in FIG. 4, a foil, screen or mesh, conductive epoxy or any other suitable conductive shielding material 38 is applied over the encapsulated cable. The shield may be applied, for example, by wrapping a conductive sheet using wrapping apparatus 36. The shielding 38 may be spirally wound around the encapsulated cable 26, wrapped longitudinally around the encapsulated cable with overlapping edges. Alternatively, the conductive epoxy may be applied via an extrusion process. Any other suitable shield application technique known in the art may also be employed. The shielding 38 adheres, to the warm or tacky dielectric to provide a uniform and integral shielded cable that enters the extrusion die 28.

In yet another embodiment of the above-described process the inner surface of the shield 38 is coated with anisotropic material 40 having z-axis conductivity. Such anisotropic materials are commercially available in tape of adhesive form from Hitachi, 3M Corporation and the assignee of the present invention. After the coated shield 48 is applied over the encapsulated cable 26 the shield 38 is dimpled at one or more of the flat conductors 16 as shown at indent 42 to provide a conductive path between the conductive shield 38 and the respective flat conductor(s) 16. In the foregoing manner, selected flat conductors 16 may be employed as ground paths and electrically coupled to the shield of the cable. Alternatively, laser ablation may be employed to conductively interconnect the shield 38 to one or more of the flat conductors 16. Following the electrical interconnection of the shield 38 to one or more of the flat conductors 16 as described above, a jacket 30 may be extruded over the shield 38 as previously discussed.

Alternatively, the dielectric film 22 may be prepunched to created an opening extending through the dielectric film 22 to one or more of the conductors 16 and a shield material may be applied via a spray technique over the dielectric films 22. Alternatively, a flexible solid conductive shield , or a conductive screen or mesh fabricated of copper, silver, aluminum or carbon may be conductively coupled to one or more of the conductors 16 through the respective prepunched openings using a suitable conductive material. Moreover, a foil, screen or mesh may be deformed so as to make contact with the conductor 16 through the prepunched opening. By way of example, the mesh may comprise a flexible mesh such as disclosed in U.S. Pat. No. 5,334,800 or any other suitable conductive mesh.

While the above-described process uses round wire that is swaged to form flat conductors, it should be appreciated that the swaging step may be omitted and a flat cable employing round conductors may be fabricated as otherwise described above. Additionally, rather than spooling round wires, flat wire stock may be employed in which case the swaging apparatus may be omitted.

It will be appreciated by those of ordinary skill in the art that modifications to and variations of the above-described process for making a flat cable and modification to and variations of the flat cable itself may be made without departing from the inventive concepts described herein. Accordingly, the invention should not be viewed as limited except by the scope and spirit of the appended claims.

What is claimed is:

1. A method for fabricating a multi-conductor flat cable comprising the steps of:
maintaining predetermined spacings between a plurality of conductors;
laminating a dielectric film to upper and lower surfaces of said conductors using a first material for form an encapsulated multi-conductor cable;
extruding a jacket of a second material over said encapsulated multi-conductor cable to form said multi-conductor cable.

2. The method of claim 1 wherein said maintaining step comprises the step of feeding said plurality of conductors through a comb.

3. The method of claim 1 wherein said maintaining step comprises the step of passing said plurality of conductors through respective grooves of a grooved roller.

4. The method of claim 1 wherein said laminating step comprises the step of laminating first and second insulating dielectric films over first and second sides of said plurality of conductors between opposing nip rollers.

5. The method of claim 4 wherein said nip rollers comprise heated nip rollers.

6. The method of claim 1 wherein said first and second materials comprise different materials.

7. The method of claim 1 wherein said first and second materials comprise the same material.

8. The method of claim 1 further including between said laminating and extruding steps the step of applying a conductive shield around said encapsulated multi-conductor cable.

9. The method of claim 1 further including between said laminating and applying steps the steps of:
prepunching said encapsulated multi-conductor cable to form an opening through at one of said upper and lower dielectric films to form an opening in said film extending to one of said plurality of conductors; and
conductively coupling said conductive shield to said one of said plurality of conductors via a conductive material extending through said opening.

10. The method of claim 8 wherein said applying step comprises the step of wrapping a foil shield around said encapsulated multi-conductor cable.

11. The method of claim 8 wherein said applying step comprises the step of extruding a conductive layer around said encapsulated multi-conductor cable.

12. The method of claim 8 wherein said applying step comprises the step of wrapping a conductive screen around said encapsulated multi-conductor cable.

13. The method of claim 8 further including the step of coating an inner surface of said shield with an anisotropic dielectric material having z axis conductivity and said applying step comprises the step of applying said shield around said encapsulated multi-conductor cable such that said anisotropic dielectric material coating abuts said encapsulated multi-conductor cable, said method further including the step of conductively coupling said shield to at least one of said plurality of conductors via said anisotropic dielectric material.

14. The method of claim 12 wherein said conductively coupling step comprises the step of dimpling said step above said at least one of said plurality of conductors.

15. The method of claim 12 wherein said conductively coupling step comprises the step of laser ablating said shield above said at least one of said plurality of conductors.

16. method of claim 1 wherein said plurality of conductors comprise generally rectangular conductors.

17. A flat multiconductor cable comprising:
a plurality of co-planar conductors spaced apart by a predetermined distance ;
a first dielectric layer comprising a first material and encapsulating said plurality of conductors to form an encapsulated flat cable; and
a jacket comprising a second material surrounding said encapsulated flat cable.

18. The cable of claim 17 wherein said first and second materials comprise different materials.

19. The cable of claim 17 further including a conductive shielding layer surrounding said encapsulated multi-conductor cable between said first dielectric layer and said jacket.

20. The cable of claim 19 wherein said conductive shielding layer comprises a conductive foil.

21. The cable of claim 19 wherein said conductive shielding layer comprises a conductive screen.

22. The cable of claim 19 wherein said conductive shielding layer comprises a conductive epoxy.

23. The cable of claim 18 further including an anisotropic dielectric between said shielding layer and said encapsulated multi-conductor cable and at least one conductive path through said anisotropic material between said shielding layer and at least one of said plurality of conductors.

24. The cable of claim 17 wherein said plurality of conductors comprise flat conductors having a generally rectangular cross section.
